(19) United States
(12) Patent Application Publication
(10) Pub. No.: US 2015/0137772 A1
(43) Pub. Date: May 21, 2015

(54) POWER FACTOR CORRECTION SUB-SYSTEM FOR MULTI-PHASE POWER DELIVERY

(71) Applicant: RICHARDS CORPORATION, Sterling, VA (US)

(72) Inventors: Koffi Mawule, Silver Spring, MD (US); Paul C. Robinson, Front Royal, VA (US)

(21) Appl. No.: 14/083,550

(22) Filed: Nov. 19, 2013

(51) Int. Cl. H02M 1/42

(52) U.S. Cl. CPC H02M 1/4216
USPC 323/205

(57) ABSTRACT

Systems and methods are disclosed for providing power factor correction (“PFC”) for multi-phase power delivery. A PFC sub-system can include multiple active PFC modules and multiple isolated DC-to-DC converters. Each active PFC module can increase a respective power factor associated with a respective phase of the multi-phase power system. Each DC-to-DC converter can be electrically connected to a respective active PFC module. Each isolated DC-to-DC converter can modify a respective DC voltage level for a respective DC voltage received from a respective active PFC module. Outputs of the isolated DC-to-DC converters are electrically connectable for providing a combined voltage or combined current to a load device. The combined voltage or combined current corresponds to the voltages received by the DC-to-DC converters from the active PFC modules.

### FIELD OF THE INVENTION

This disclosure relates generally to electrical devices and more particularly relates to power factor correction sub-systems for multi-phase power delivery.

### BACKGROUND

Multi-phase power systems may be used for providing power to electrical devices. For example, an airplane or other vehicle may include a three-phase power system to provide power to electrical devices in the airplane.

It may be desirable to increase the power factor for multi-phase power systems (i.e., the ratio between real power provided to load devices and apparent power in the system). Current solutions for improving the power factor of multi-phase power systems may present disadvantages. For example, transformers or other devices used to provide power factor correction may cause excessive voltage or current harmonics in the power system. Such devices may also be larger than desirable, thereby presenting safety concerns or potential malfunctions in weight-sensitive operating environments such as airplanes.

Improved systems and methods for providing power factor correction for multi-phase power delivery are therefore desirable.

### SUMMARY

Systems and methods are disclosed for providing power factor correction for multi-phase power delivery.

In one aspect, a power factor correction sub-system is provided. The power factor correction sub-system can include multiple active power factor correction modules and multiple isolated DC-to-DC converters. Each active power factor correction module can increase a respective power factor associated with a respective phase of the multi-phase power system. Each DC-to-DC converter can be electrically connected to a respective active power factor correction module. Each isolated DC-to-DC converter can modify a respective DC voltage level for a respective DC voltage received from a respective active power factor correction module. Outputs of the isolated DC-to-DC converters are electrically connectable for providing a combined voltage or combined current to a load device. The combined voltage or combined current corresponds to the voltages received by the DC-to-DC converters from the active power factor correction modules.

In another aspect, a method is provided. The method involves determining an operating constraint associated with a voltage or current provided to a load device by a multi-phase power system. The method also involves selecting multiple active power factor correction modules based on the operating constraint. The method also involves providing a power factor correction sub-system for use with the multi-phase power system and the load device. The power factor correction sub-system can include the active power factor correction modules that are selected based on the operating constraint. Each active power factor correction module can increase a respective power factor associated with a respective phase of the multi-phase power system. The power factor correction sub-system can also include multiple isolated DC-to-DC converters. Each isolated DC-to-DC converter is configured to modify a respective DC voltage level for a respective DC voltage received from a respective active power factor correction module. Electrically connecting the isolated DC-to-DC converters together can provide the voltage or the current to the load device. The voltage or current corresponds to the voltages received by the DC-to-DC converters from the active power factor correction modules.

These illustrative aspects and features are mentioned not to limit or define the disclosure, but to provide examples to aid understanding of the concepts disclosed in this application. Other aspects, advantages, and features of the present disclosure will become apparent after review of the entire application.

### BRIEF DESCRIPTION OF THE DRAWINGS

FIG. 1 is a block diagram depicting an example of a configuration for a power factor correction (“PFC”) sub-system that provides a combined voltage to a load device according to one aspect of the present disclosure.

FIG. 2 is a block diagram depicting an example of a configuration for the PFC sub-system that provides a combined current to the load device according to one aspect of the present disclosure.

FIG. 3 is a block diagram depicting an example of an alternative configuration for the PFC sub-system that provides a combined voltage to the load device according to one aspect of the present disclosure.

FIG. 4 is a block diagram depicting an example of an alternative configuration for the PFC sub-system that provides a combined current to the load device according to one aspect of the present disclosure.

FIG. 5 is a flow chart depicting an example of a method for providing a PFC sub-system according to one aspect of the present disclosure.

### DETAILED DESCRIPTION

Systems and methods are disclosed for providing power factor correction (“PFC”) for multi-phase power delivery.

A PFC sub-system can include multiple active PFC modules electrically connected to multiple isolated DC-to-DC converters. Inputs of the active PFC modules can be connected to a multi-phase power system. The connections to the multi-phase power system can include connections to a neutral line or phase-to-phase connections. Each active PFC module can increase a respective power factor associated with a respective phase of the multi-phase power system. For example, the PFC sub-system can offset the reactive power associated a load device that is powered by the multi-phase power system. Offsetting the reactive power can cause the load device to appear as a purely resistive load with respect to the multi-phase power system.

Each isolated DC-to-DC converter can reduce or otherwise modify a respective DC voltage received from a respective active PFC module based on the voltage or current specifications of the load device. Outputs of the isolated DC-to-DC converters can be connected in different topologies based on the load device. In some aspects, the isolated DC-to-DC converters can be connected in series to provide a combined voltage to the load device. The combined voltage can be a combination of respective voltages outputted by respective DC-to-DC converters that correspond to respective output voltages of the active PFC modules. In other aspects, the isolated DC-to-DC converters can be connected in parallel to provide a combined current to the load device. The combined current can be a combination of respective currents outputted by respective DC-to-DC converters that correspond to respective output voltages of the active PFC modules.

In some aspects, the PFC sub-system can provide power factor correction that complies with operating requirements regarding current or voltage harmonics for certain operating environments (e.g., aircraft, buildings, etc.). For example, the PFC sub-system can be configured to provide a desired harmonic performance over a specified range of frequencies. In additional or alternative aspects, the PFC sub-system can be designed from relatively lightweight components, thereby complying with weight requirements for certain operating environments.

These illustrative examples are given to introduce the reader to the general subject matter discussed here and are not intended to limit the scope of the disclosed concepts. The following sections describe various additional aspects and examples with reference to the drawings in which like numerals indicate like elements. The features discussed herein are not limited to any particular hardware architecture or configuration.

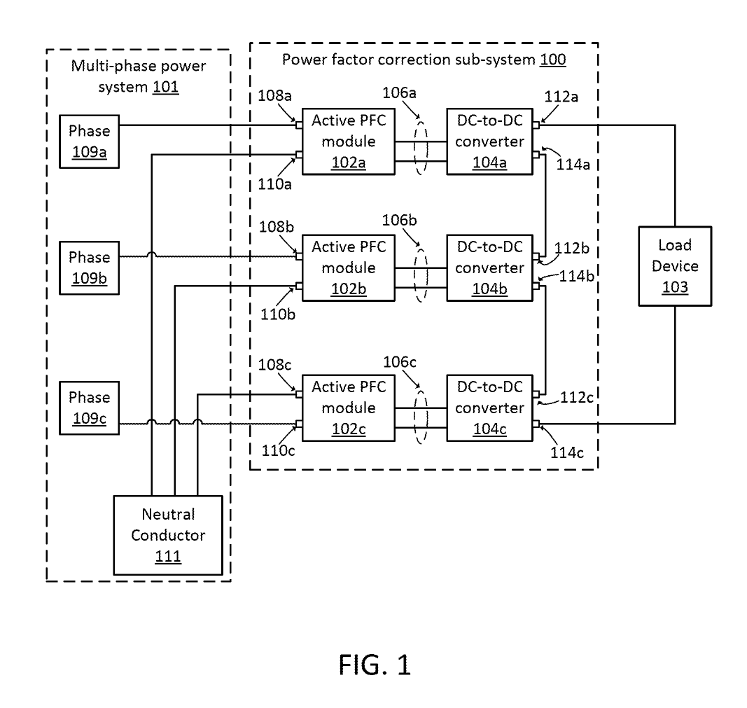

FIG. 1 is a block diagram depicting an example of a configuration for a PFC sub-system 100 that provides a combined voltage to a load device 103 according to one aspect. The PFC sub-system 100 can improve a magnitude of a power factor associated with the load device 103 by modifying voltage and/or current characteristics of power provided from a multi-phase power system 101 to the load device 103.

The PFC sub-system 100 can include active PFC modules 102a-c and isolated DC-to-DC converters 104a-c. Each of the active PFC modules 102a-c can be electrically connected to a respective one of the DC-to-DC converters 104a-c via a respective one of DC links 106a-c.

The multi-phase power system 101 can provide multiple AC currents having a common frequency that are phase shifted from one another. For illustrative purposes, FIG. 1 depicts functional blocks for three phases 109a-c corresponding to three phase-shifted AC currents having a common frequency. The AC currents at phases 109a-c can be respectively provided to the active PFC modules 102a-c via respective input terminals 108a-c. The multi-phase power system 101 can also include a neutral conductor 111. The neutral conductor 111 can be electrically connected to each of the active PFC modules 102a-c via respective terminals 110a-c. A non-limiting example of a multi-phase power system 101 is a three-phase power system used to power electrical devices in an aircraft.

Each of the active PFC modules 102a-c can improve a respective power factor associated with a respective one of the phases 109a-c. For example, each of the active PFC modules 102a-c can cause the PFC sub-system 100 and the load device 103 to function in a manner similar to that of a purely resistive load with respect to the multi-phase power system 101. Each of the active PFC modules 102a-c can include a suitable device or group of devices configured to offset the reactive power associated with the load device 103 by modifying the waveform of the AC current provided to the load device 103 such that the voltage and current received by the load device 103 are in phase with one another.

Any suitable active PFC modules 102a-c can be used. Non-limiting examples of suitable active PFC modules include average current control PFC converters, peak current control PFC converters, hysteresis control PFC converters, borderline control PFC converters, discontinuous current pulse-width modulation control PFC converters, etc.

The DC-to-DC converters 104a-c can allow voltages or currents at the outputs (i.e., the DC links 106a-c) of the active PFC modules 102a-c to be combined. One or more of the outputs of the active PFC modules 102a-c may have a different potential as compared to other active PFC modules in the PFC sub-system 100. The differing potentials may present the risk of causing excessive current to be provided to the load device 103 if the load device 103 were to be directly connected to the combined outputs of the active PFC modules 102a-c. The isolated DC-to-DC converters 104a-c can reduce the voltages across the DC links 106a-c to voltage levels usable by the load device 103.

Each of the DC-to-DC converters 104a-c can modify a respective DC voltage at a respective output of a respective one of the active PFC modules 102a-c. Each DC voltage outputted by one of the active PFC modules 102a-c can be converted to a lower voltage by a respective one of the DC-to-DC converters 104a-c. The DC-to-DC converters 104a-c can be selected or configured based on the power requirements of the load device 103. For example, a high voltage provided by the multi-phase power system 101 (e.g., 115 V) can be converted to a lower voltage by the DC-to-DC converters 104a-c for provision to the load device 103.

The DC-to-DC converters 104a-c can be electrically connected to provide a combined voltage to the load device 103. For example, as depicted in FIG. 1, the load device 103 can be electrically connected to the PFC sub-system 100 via a terminal 112a of the DC-to-DC converter 104a and a terminal 114c of the DC-to-DC converter 104c. The DC-to-DC converters 104a-c can be connected in series by electrically connecting a terminal 112c of the DC-to-DC converter 104c to a terminal 114b of the DC-to-DC converter 104c and electrically connecting a terminal 112b of the DC-to-DC converter 104b to a terminal 114a of the DC-to-DC converter 104a.

Any suitable DC-to-DC converters 104a-c can be used. Non-limiting examples of suitable DC-to-DC converters include flyback converters, forward converters, half or full bridge converters, push-pull converters, phase-shifted full bridge converters, etc.

The PFC sub-system 100 can be implemented in any suitable manner. In a non-limiting example, the PFC sub-system 100 can be an integrated circuit. The integrated circuit can include active PFC modules 102a-c and DC-to-DC converters 104a-c that are electrically connected via a printed circuit board.

For illustrative purposes, FIG. 1 depicts the PFC sub-system 100 for use with a multi-phase power system 101 having three phases 109a-c. However, a PFC sub-system 100 can be used with a multi-phase power system 101 having any number of phases. The PFC sub-system 100 can include a respective active PFC module for each phase of the multi-phase power system 101.

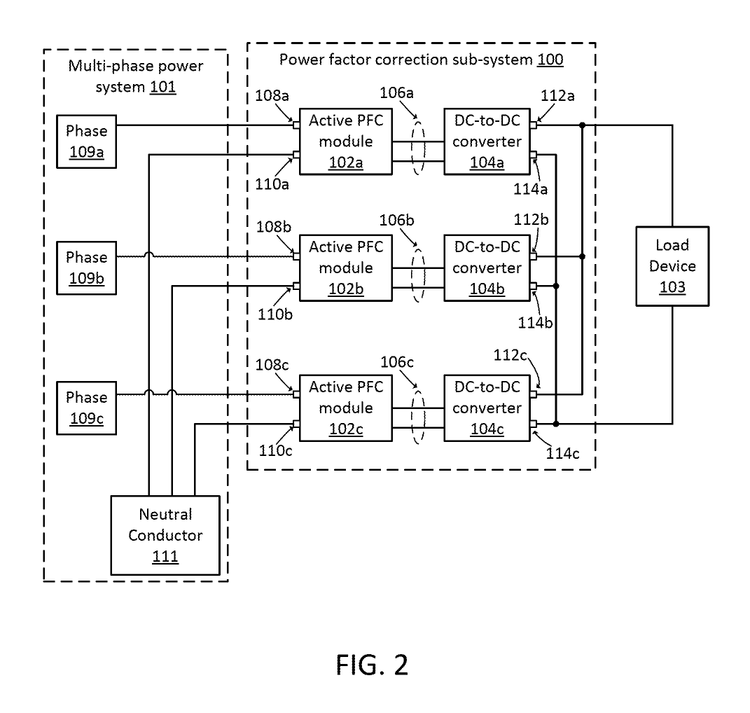

In some aspects, the load device 103 may require a higher current. The PFC sub-system 100 can be configured to provide the current. For example, FIG. 2 is a block diagram depicting an example of a configuration for the PFC sub-system 100 that provides a combined current to the load device 103 according to one aspect.

The load device 103 can be electrically connected in parallel to each of the terminals 112a-c of the respective DC-to-DC converters 104a-c and electrically connected in parallel to the terminals 114a-c of the respective DC-to-DC converters 104a-c. The terminals 112a-c being connected in parallel can allow output currents from the DC-to-DC converters 104a-c to be combined. The combined current can be provided to the load device 103.

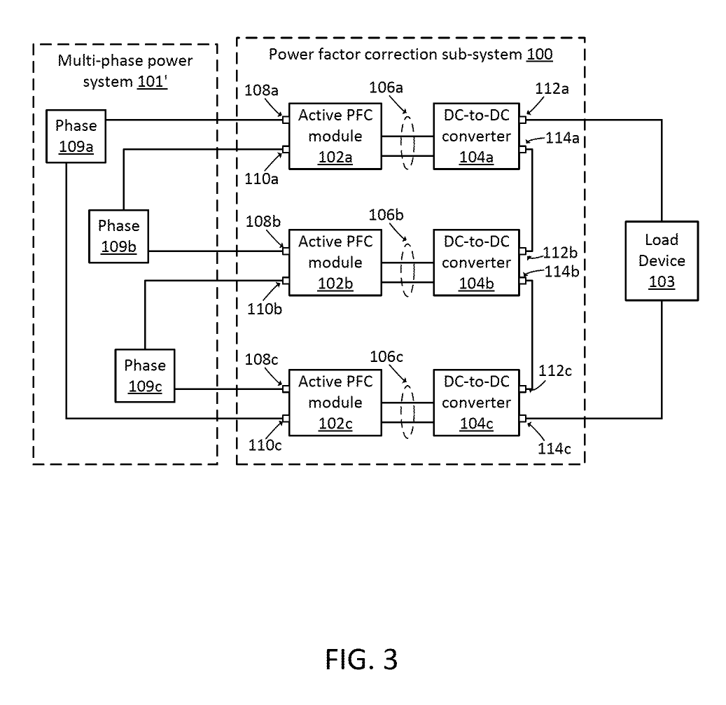

In some aspects, the neutral conductor 111 may be omitted from the multi-phase power system 101. For example, FIG. 3 is a block diagram depicting an example of an alternative configuration for the PFC sub-system 100 that provides a combined voltage to the load device 103 according to one aspect. The alternative configuration can involve phase-to-phase inputs to the active PFC modules.

The configuration depicted in FIG. 3 can include each of the terminals 110a-c receiving a respective AC current at a different phase of the multi-phase power system 101′, thereby providing phase-to-phase connections for each of the active PFC modules 102a-c. The AC currents at phases 109a-c can be respectively provided to the active PFC modules 102a-c via respective input terminals 108a-c. The AC currents at phases 109a-c can also be provided to other terminals of the active PFC modules 102a-c. For example, the terminal 110a can be electrically connected to the phase 109b, the terminal 110b can be electrically connected to the phase 109c, and the terminal 110c can be electrically connected to the phase 109a.

The configuration depicted in FIG. 3 can also include the DC-to-DC converters being connected to the load device 103 in series, as described above with respect to FIG. 1.

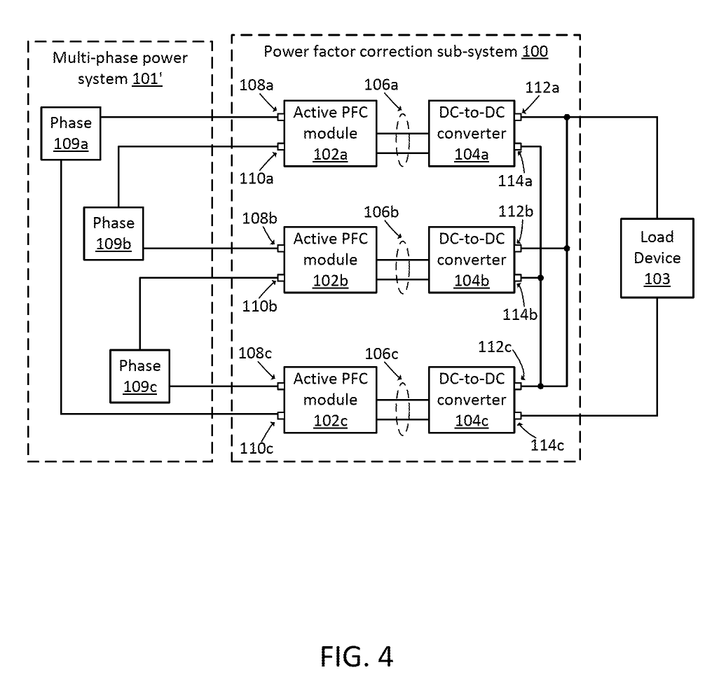

FIG. 4 is a block diagram depicting an example of an alternative configuration for the PFC sub-system 100 that provides a combined current to the load device 103 according to one aspect. The configuration depicted in FIG. 4 can include the DC-to-DC converters being connected to the load device 103 in parallel, as described above with respect to FIG. 2. The configuration depicted in FIG. 4 can include the active PFC modules 102a-c being connected to the multi-phase power system 101′ via phase-to-phase connections, as described above with respect to FIG. 3.

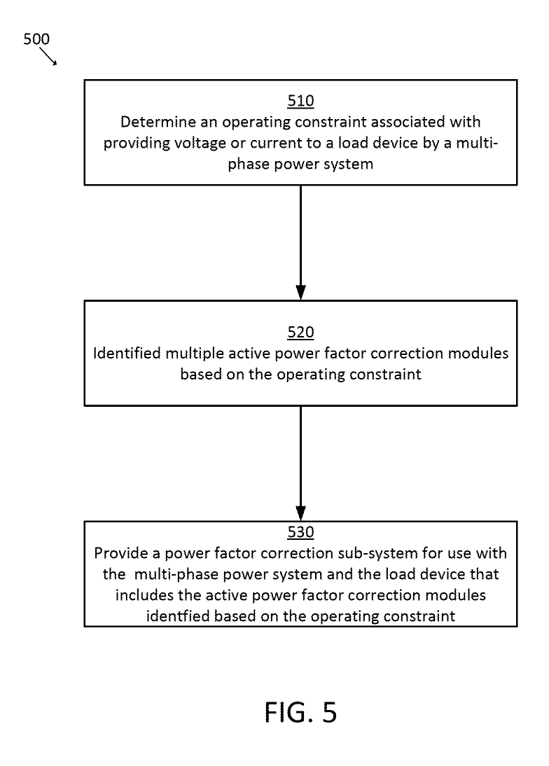

A PFC sub-system 100 can be selected, designed, manufactured, or otherwise provided for any suitable operating environment. FIG. 5 is a flow chart depicting an example of a method 500 for providing a PFC sub-system 100 according to one aspect.

The method 500 involves determining an operating constraint associated with providing a voltage or current to a load device 103 by a multi-phase power system, as depicted in block 510. The operating constraint can include any restriction, requirement, or other operating condition associated with providing voltage or current to the load device 103. An operating constraint can be determined based on aspects such as (but not limited to) features or other characteristics of the load device 103, the operating environment in which the load device 103 is installed or otherwise used, features or other characteristics of the multi-phase power system 101. Any number of operating constraints (including one) can be determined at block 510.

In some aspects, an operating constraint can include harmonics associated with the voltage or current provided to the load device 103. For example, a load device 103 may be an electrical device installed in an operating environment that is subject to one or more safety requirements or other operating standards with respect to electrical power delivery. Non-limiting examples of such operating environments include airplanes or other vehicles, certain buildings or other structures, etc. The safety requirements for the operating environment may specify that current or voltage harmonics generated by non-linear loads (e.g., the load device 103) may not exceed a threshold amplitude or that spurious harmonics may not be generated. The threshold amplitude for current or voltage harmonics can be determined as an operating constraint.

In additional or alternative aspects, an operating constraint can include a weight associated with the PFC sub-system 100. For example, the load device 103 may be installed or otherwise used in an aircraft or other vehicle. The weight of the PFC sub-system 100 used with the load device 103 may present issues such as safety concerns or operational concerns (e.g., preventing take-off of an aircraft or limiting the cargo carrying capacity of the aircraft or other vehicle). The operating constraint associated with the PFC sub-system 100 may include minimizing the weight of the PFC sub-system 100 or limiting the maximum weight of the PFC sub-system 100.

In additional or alternative aspects, an operating constraint can include balancing phases of multi-phase power provided to the load device 103. For example, an operating constraint may require that each of the phases 109a-c of the multi-phase power system 101 provide an equal amount of current or an amount of current that does not deviate beyond a specified range.

The method 500 also involves identifying multiple active PFC modules based on the operating constraint, as depicted in block 520. For example, specific implementations or configurations of the active PFC modules 102a-c can be identified that satisfy one or more conditions specified by the operating constraint. One non-limiting example of identifying the active PFC modules includes selecting the active PFC modules for use in designing or building a PFC sub-system 100. Another non-limiting example of identifying the active PFC modules includes selecting a PFC sub-system 100 that includes active PFC modules 102a-c that satisfy the operating constraint.

In some aspects, specific implementations or configurations of active PFC modules 102a-c can be identified that minimize undesirable effects in accordance with the operating constraint(s) of an operating environment. In one non-limiting example, specific active PFC modules 102a-c may be identified that minimize voltage or current harmonics associated with the voltage or current provided to the load device 103. Specific active PFC modules 102a-c may be also identified that minimize the voltage or current harmonics over a specified range of frequencies used by the multi-phase power system 101. In another non-limiting example, specific active PFC modules 102a-c may be identified that minimize the weight of the PFC sub-system 100 or that prevent the weight of the PFC sub-system 100 from exceeding a maximum weight. In another non-limiting example, specific active PFC modules 102a-c may be identified that provide a balanced provision of current among the phases 109a-c of the multi-phase power system 101.

The method 500 also involves providing a PFC sub-system 100 for use with the multi-phase power system and the load device that includes the active PFC modules that are identified based on the operating constraint, as depicted in block 530. In one non-limiting example, providing the PFC sub-system 100 can involve designing or manufacturing the PFC sub-system 100 having the active PFC modules 102a-c identified at block 520. In another non-limiting example, providing the PFC sub-system 100 can involve obtaining a previously-manufactured PFC sub-system 100 that includes the active PFC modules 102a-c identified at block 520.

The foregoing description of aspects and features of the disclosure, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of this disclosure. Aspects and features from each example disclosed can be combined with any other example. The illustrative examples described above are given to introduce the reader to the general subject matter discussed here and are not intended to limit the scope of the disclosed concepts.

What is claimed is:

1. A power factor correction sub-system comprising:
multiple active power factor correction modules electrically connectable to a multi-phase power system, wherein each active power factor correction module is configured to increase a respective power factor magnitude associated with a respective phase of the multi-phase power system; and
multiple isolated DC-to-DC converters electrically connected to the respective active power factor correction modules, wherein each isolated DC-to-DC converter is configured to modify a respective DC voltage level for a respective DC voltage received from a respective active power factor correction module,
wherein the isolated DC-to-DC converters are electrically connectable for providing a combined voltage or combined current to a load device, wherein the combined voltage or the combined current corresponds to the DC voltages received from the active power factor correction modules.

2. The power factor correction sub-system of claim 1, wherein each active power factor correction module comprises at least one additional respective input connectable to a neutral conductor of the multi-phase power system.

3. The power factor correction sub-system of claim 1, wherein each active power factor correction module comprises at least one additional respective input connectable to another respective source of another phase of the multi-phase power system.

4. The power factor correction sub-system of claim 1, wherein the outputs of the isolated DC-to-DC converters are electrically connected in series for providing the combined voltage to the load device.

5. The power factor correction sub-system of claim 1, wherein the outputs of the isolated DC-to-DC converters are electrically connected in parallel for providing the combined current to the load device.

6. A method comprising:
determining an operating constraint associated with a voltage or current provided to a load device by a multi-phase power system;
selecting multiple active power factor correction modules based on the operating constraint; and
providing a power factor correction sub-system for use with the multi-phase power system and the load device, the power factor correction sub-system comprising:
the active power factor correction modules selected based on the operating constraint, wherein each active power factor correction module is configured to increase a respective power factor magnitude associated with a respective phase of the multi-phase power system; and
multiple isolated DC-to-DC converters, wherein each isolated DC-to-DC converter is configured to modify a respective DC voltage level for a respective DC voltage received from a respective active power factor correction module,
wherein electrically connecting the isolated DC-to-DC converters together provides the voltage or the current to the load device, wherein the voltage or the current is based on the DC voltages received from the active power factor correction modules.

7. The method of claim 6, wherein the operating constraint comprises harmonics associated with the current provided to the load device.

8. The method of claim 6, wherein the operating constraint comprises a balance among phases of multi-phase power provided to the load device.

9. The method of claim 6, wherein the operating constraint comprises a weight associated with the power factor correction sub-system.

10. The method of claim 6, further comprising at least one of:
connecting at least one input of each active power factor correction module to a neutral conductor of the multi-phase power system; or
connecting at least one input of each active power factor correction module to a conductor providing a phase of the multi-phase power system and at least one additional input of each active power factor correction module to an additional conductor providing an additional phase of the multi-phase power system.

11. The method of claim 6, further comprising electrically connecting outputs of the isolated DC-to-DC converters in series for providing the voltage to the load device.

12. The method of claim 6, further comprising electrically connecting outputs of the isolated DC-to-DC converters in parallel for providing the current to the load device.
